(19) United States
(12) Patent Application Publication
(10) Pub. No.: US 2023/0216734 A1
(43) Pub. Date: Jul. 6, 2023

(54) ZERO CONFIGURATION FOR ZERO-TOUCH DEPLOYMENT (ZTD)

(71) Applicant: Cisco Technology, Inc., San Jose, CA (US)

(72) Inventors: Manoj Kumar Kushwaha, Bangalore (IN); Scott Taft Potter, Stratford, CT (US); David Scott McCowan, Cary, NC (US); Shailendra Bhargava, San Ramon, CA (US)

(21) Appl. No.: 17/830,777

(22) Filed: Jun. 2, 2022

(30) Foreign Application Priority Data
Dec. 30, 2021 (IN) 202141061687.0

(51) Int. Cl. H04L 41/0806; H04L 41/08; H04L 61/4511

(52) U.S. Cl. CPC H04L 41/0806; H04L 41/0886; H04L 61/4511

(57) ABSTRACT

The present disclosure is directed to techniques for streamlining the process of configuring IoT devices during their onboarding to a network by eliminating the need for pre-provisioning IoT devices with zero-touch deployment (ZTD) specific configurations during manufacturing. In one aspect, a method includes receiving, from an IoT device connected to a ZTD service, a message for establishing a connection to the ZTD service; provisioning, at the zero-touch deployment service, the IoT device with ZTD specific configurations; and completing, at the zero-touch deployment service, initial bootstrapping of the IoT device to establish the connection to the ZTD service using the ZTD specific configurations.

### CROSS-REFERENCE TO RELATED APPLICATIONS

This application claims the benefit of priority to Indian Provisional Patent Application No. 202141061687.0, filed Dec. 30, 2021 and entitled “ZERO CONFIGURATION FOR ZERO TOUCH DEPLOYMENT,” the disclosure of which is herein incorporated by reference in its entirety.

### TECHNICAL FIELD

The present technology pertains to wireless networks, and more particularly to providing streamlining upfront configuration and onboarding of IoT devices deployed in a network using zero-touch deployment (ZTD).

### BACKGROUND

As Internet-of-Things (IoT) devices continue to grow in popularity, so too may the complexity of many IoT deployments. For example, enterprise IoT deployments may include thousands of different IoT devices, many of which consume wireless data and/or interact with multiple different networked entities. Among other challenges, configuration of IoT devices to be onboarded remains a process that inhibits scaling of such deployments. Upfront configurations of IoT device to connect to a network and an associated Zero-Touch-Deployment (ZTD) service. These configurations are put inside a ZTD agent software, which a target IoT device may use for zero-touch deployment. These configurations can include ZTD service Uniform Resource Location (URL), ZTD service Root Certificate, ZTD Access Point Name (APN), optional connection credentials, etc.

Currently, these configurations are required to be put into the IoT devices during manufacturing. Moreover, these configuration parameters can change over time (e.g., a ZTD URL may change, a ZTD certificate may expire, credentials may change, etc.). The requirements for such pre-configuration and the static nature thereof, not only inhibits an easy and streamlined onboarding process for IoT devices, it also forces enterprises to be tightly coupled to a ZTD solution provider.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates an example cloud computing architecture, according to some aspects of the present disclosure;

FIG. 2 illustrates an example fog computing architecture, according to some aspects of the present disclosure;

FIG. 3 illustrates an example architecture for the zero-touch deployment (ZTD) of network devices, according to some aspects of the present disclosure;

FIG. 4 illustrates an example ZTD agent, according to some aspects of the present disclosure;

FIG. 5 describes a process for zero-touch configuration of IoT devices, according to some aspects of the present disclosure;

FIG. 6 illustrates an example of a network device, according to some aspects of the present disclosure; and

FIG. 7 illustrates an example computing system, according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

Disclosed are systems, apparatuses, methods, and computer-readable media for streamlining the process of configuring IoT devices during their onboarding to a network and its associated ZTD services. Techniques disclosed herein may be used during initial bootstrapping for connecting IoT devices to a ZTD service. More specifically, ZTD specific configurations needed for connecting IoT devices to a LTD service (e.g., a ZTD specific APN and URL) are obtained during runtime and provisioned on the IoT device at the time of connection instead of having to pre-provision each IoT device during manufacturing with ZTD specific APNs, URLs, etc.

In one aspect, a method includes receiving, from an IoT device connected to a zero-touch deployment (ZTD) service, a message for establishing a connection to the ZTD service; provisioning, at the zero-touch deployment service, the IoT device with ZTD specific configurations; and completing, at the zero-touch deployment service, initial bootstrapping of the IoT device to establish the connection to the ZTD service using the ZTD specific configurations.

In another aspect, the ZTD specific configurations include a ZTD specific Access Point Name (APN) and a ZTD specific Uniform Resource Locator (URL).

In another aspect, provisioning the IoT device with the ZTD specific configurations includes replacing a non-ZTD specific APN in the message with the ZTD specific APN and replacing a non-ZTD specific URL included in the message with the ZTD specific URL.

In another aspect, wherein replacing the non-ZTD specific URL with the ZTD specific URL includes resolving the non-ZTD specific URL using a Domain Name Service (DNS) resolver.

In another aspect, the non-ZTD specific APN is a blank APN definition and the blank APN definition is replaced with the ZTD specific APN.

In another aspect, the blank APN is included in a PDP context definition within the message.

In another aspect, the IoT device is not pre-provisioned with the ZTD configuration when the message is received at the ZTD service.

In one aspect, a server associated with a zero-touch deployment (ZTD) service includes one or more memories having computer-readable instructions stored therein and one or more processors. The one or more processors are configured to execute the computer-readable instructions to receive, from an IoT device connected to the zero-touch deployment (ZTD) service, a message for establishing a connection to the ZTD service; provision the IoT device with ZTD specific configurations; and complete initial bootstrapping of the IoT device to establish the connection to the ZTD service using the ZTD specific configurations.

In one aspect, one or more non-transitory computer-readable media include computer-readable instructions, which when executed by one or more processors of a zero-touch deployment (ZTD) server, cause the ZTD server to receive, from an IoT device connected to the zero-touch deployment (ZTD) server, a message for establishing a connection to the ZTD server; provision the IoT device with ZTD specific configurations; and complete initial bootstrapping of the IoT device to establish the connection to the ZTD server using the ZTD specific configurations.

### Example Embodiments

Enterprises may utilize IoT devices for various applications and tasks. To manage their operation as well as a host of other devices and applications, enterprises may establish a network (Wi-Fi and/or cellular) via any number of providers of enterprise network solutions.

Deployment and management of IoT devices within an enterprise network can be a complex process, particularly as the number of such IoT devices and their applications increase. Solutions for alleviating or automating some parts of the process of deploying and managing IoT devices have been proposed. On such service is a ZTD service such as ZTD services developed and offered by Cisco, Inc. of San Jose, Calif.

There are a number of upfront configurations that have to be made to IoT device to connect to a particular ZTD service within an enterprise network. These configurations are put inside a ZTD agent software, which a target IoT device may use for zero-touch deployment. These configurations can include ZTD service Uniform Resource Location (URL), ZTD service Root Certificate. ZTD Access Point Name (APN), optional connection credentials, etc. Currently, these configurations are required to be put into the IoT devices during manufacturing. Moreover, these configuration parameters can change over time (e.g., a ZTD URL may change, a ZTD certificate may expire, credentials may change, etc.). The requirement for such pre-configuration and the static nature thereof, not only inhibits an easy and streamlined onboarding process for IoT devices, it also forces enterprises to be tightly coupled to a single ZTD solution provider. Techniques disclosed in this disclosure eliminate the need for preconfiguring ZTD specific configurations such as ZTD APN, URL, etc.

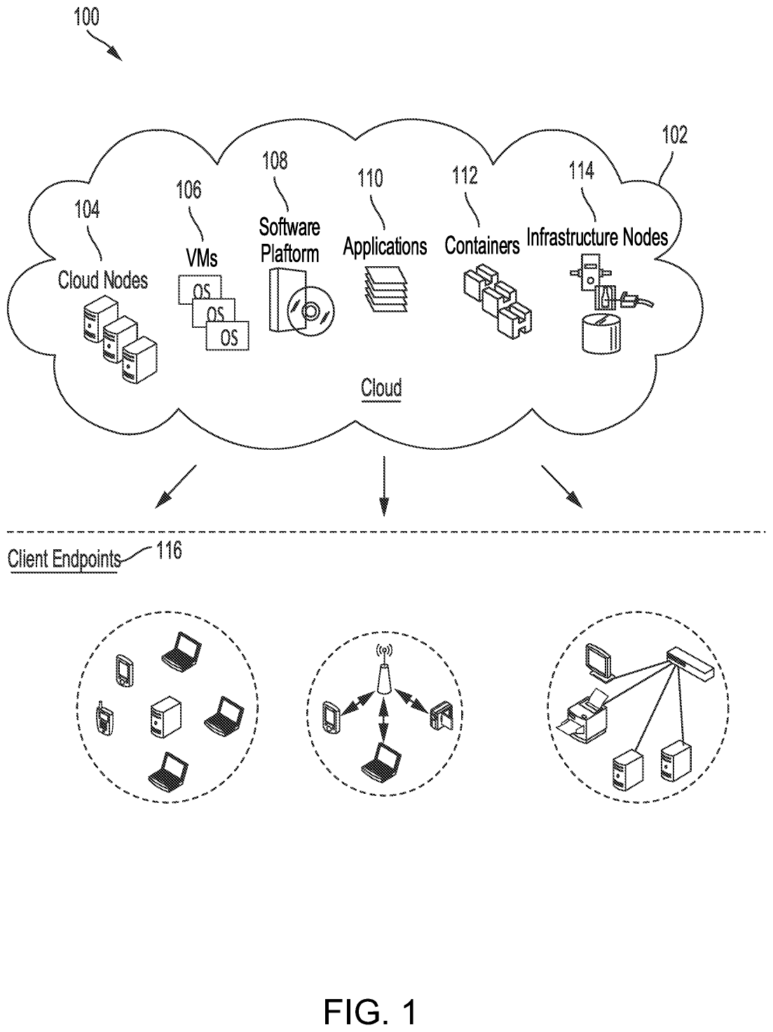

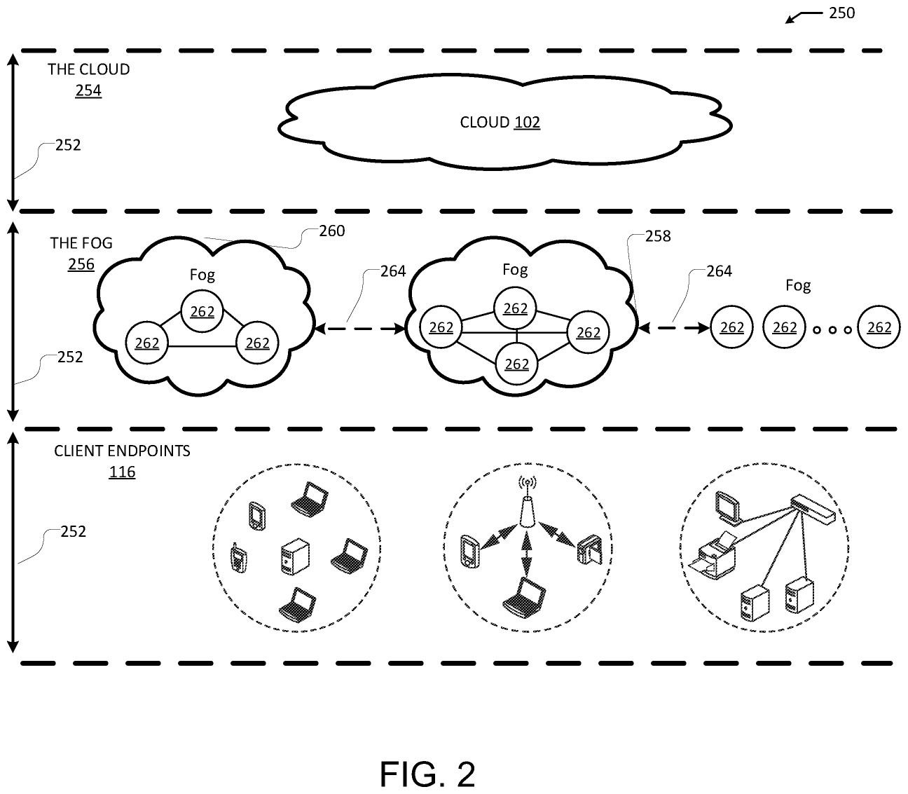

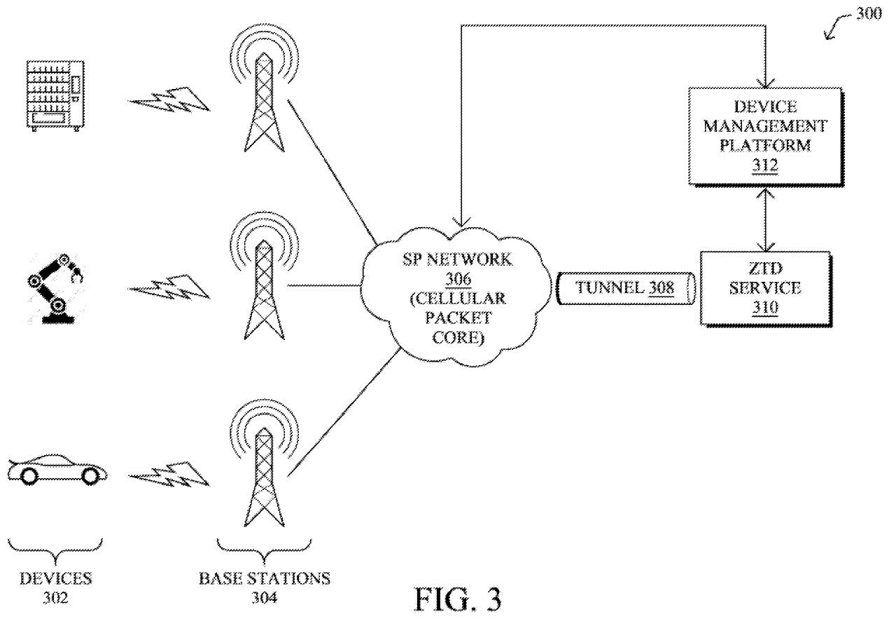

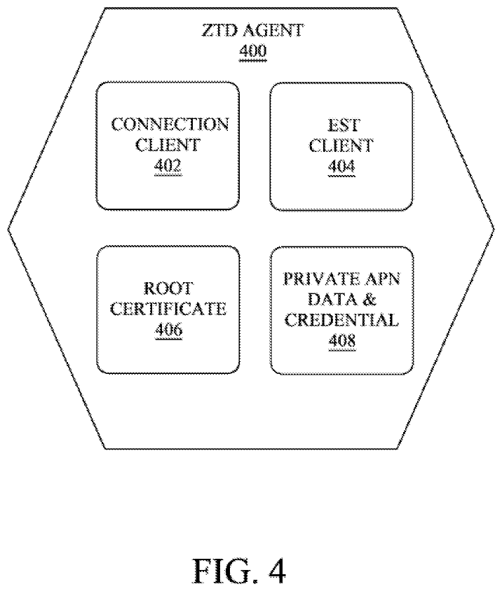

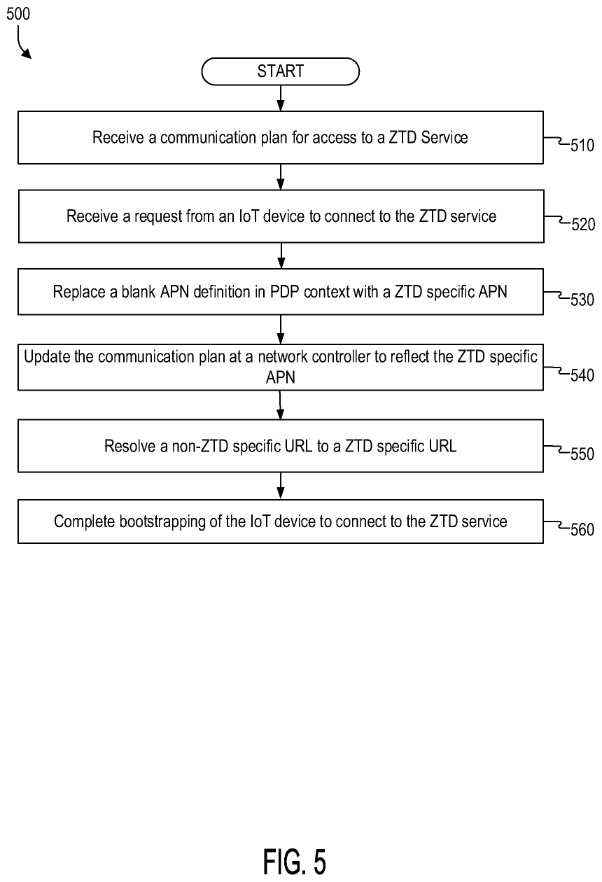

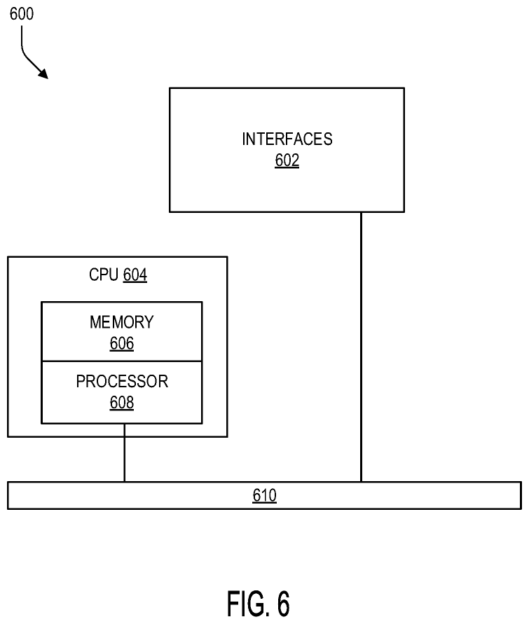

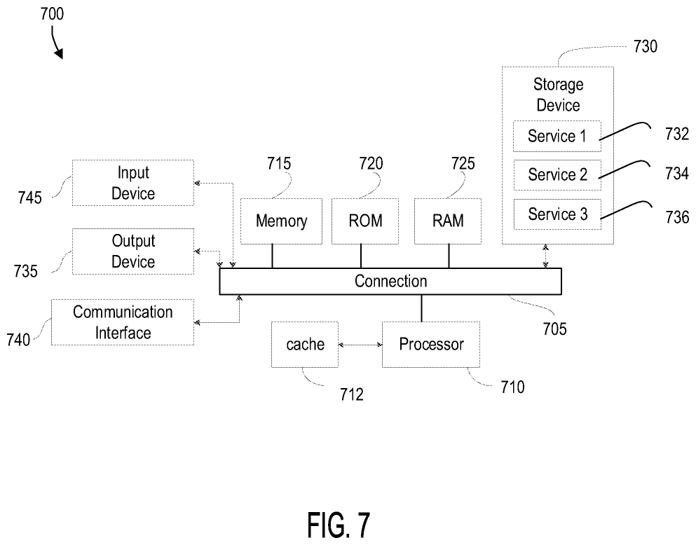

A general description of example enterprise network environments and architectures for network data access and services, are described first with reference to FIGS. 1 and 2. One or more examples of a ZTD architecture and ZTD agent are described with reference to FIGS. 3 and 4. Example processes for adaptive network traffic control policies for ZTD and/or dynamic reconfiguration of IoT devices are described next with reference to FIG. 5. The discussion then concludes with a brief description of example devices, as illustrated in FIGS. 6 and 7.

FIG. 1 illustrates an example cloud computing architecture, according to some aspects of the present disclosure. Cloud computing architecture 100 can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 2 illustrates an example fog computing architecture, according to some aspects of the present disclosure. The fog computing architecture 250 can include the cloud layer 254, which includes the cloud 102 of FIG. 1 and any other cloud system or environment, and the fog layer 256, which includes fog nodes 262. The client endpoints 116 (same as in FIG. 1) can communicate with the cloud layer 254 and/or the fog layer 256. The architecture 250 can include one or more communication links 252 between the cloud layer 254, the fog layer 256, and the client endpoints 116. Communications can flow up to the cloud layer 154 and/or down to the client endpoints 116.

The fog layer 256 or “the fog” provides the computation, storage and networking capabilities of traditional cloud networks, but closer to the endpoints. The fog can thus extend the cloud 102 to be closer to the client endpoints 216. The fog nodes 262 can be the physical implementation of fog networks. Moreover, the fog nodes 262 can provide local or regional services and/or connectivity to the client endpoints 116. As a result, traffic and/or data can be offloaded from the cloud 102 to the fog layer 256 (e.g., via fog nodes 262). The fog layer 256 can thus provide faster services and/or connectivity to the client endpoints 116, with lower latency, as well as other advantages such as security benefits from keeping the data inside the local or regional network(s).

The fog nodes 262 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 262 can be deployed within fog instances 258, 260. The fog instances 258, 258 can be local or regional clouds or networks. For example, the fog instances 256, 258 can be a regional cloud or data center, a local area network, a network of fog nodes 262, etc. In some configurations, one or more fog nodes 262 can be deployed within a network, or as standalone or individual nodes, for example. Moreover, one or more of the fog nodes 262 can be interconnected with each other via links 264 in various topologies, including star, ring, mesh or hierarchical arrangements, for example.

In some cases, one or more fog nodes 262 can be mobile fog nodes. The mobile fog nodes can move to different geographical locations, logical locations or networks, and/or fog instances while maintaining connectivity with the cloud layer 254 and/or the endpoints 116. For example, a particular fog node can be placed in a vehicle, such as an aircraft or train, which can travel from one geographical location and/or logical location to a different geographical location and/or logical location. In this example, the particular fog node may connect to a particular physical and/or logical connection point with the cloud 254 while located at the starting location and switch to a different physical and/or logical connection point with the cloud 254 while located at the destination location. The particular fog node can thus move within particular clouds and/or fog instances and, therefore, serve endpoints from different locations at different times.

FIG. 3 illustrates an example architecture for the zero-touch deployment (ZTD) of network devices, according to some aspects of the present disclosure. Architecture 300 may include any number of IoT devices 302 that are to be onboarded to a device management platform 312, such as Control Center developed by Cisco Systems, Inc., or the like. In some examples, onboarding of base stations 304 to device management platform 312 may be facilitated by a ZTD service 310 that communicates with IoT devices 302 via a cellular network that comprises any number of base stations 304 (e.g., cell towers, e-NodeBs, etc.) and a service provider (SP) network 306 that functions as the packet core for the cellular network. It is noted that, while ZTD service 310 and device management platform 312 are shown as distinct entities in architecture 300, in some cases the function(s) of ZTD service 310 and/or device management platform 312 may be combined or omitted.

In some examples, the IoT devices 302 can include, but are not limited to, cellular phones, laptops, tablets, vending equipment, automation equipment, vehicles, sensors (e.g., temperature sensors, pressure sensors, humidity sensors, etc.), actuators, drones, other forms of IoT devices, and the like. The IoT devices 302 may be the same as client endpoints 116 described above with reference to FIGS. 1 and 2. In some cases, each IoT device 302 may be configured to communicate via a cellular connection with a cellular network. Accordingly, each IoT device 302 may include a subscriber identification module (SIM) card, eSIM, iSIM, or the like.

Subscriber identification module (SIM) cards can be removable cards that store the authentication information needed for a device (e.g., IoT devices 302) to access a cellular network. For example, the authentication information can include a device's international mobile subscriber identity (IMSI) number, integrated circuit card ID (ICCID), etc. In some examples, the SIM can be used as the root of trust for purposes of bootstrapping onboarding of the IoT device(s) 302 to a corresponding management platform 312.

In some cases, SIMs may be owned by service providers (e.g., also referred to as mobile network operators). In some examples, eSIMs can be used to provide switching between service providers without needing to physically swap SIM cards. Instead of taking the form of a removable card, an eSIM can be provided as a much smaller chip that is permanently soldered onto the device. In addition, eSIMs support remote management, which can allow an administrator to easily change the account or profile of a given device and/or migrate the device to a different cellular network.

iSIMs can additionally, or alternatively, be utilized according to one or more examples of the present disclosure. Like eSIMs, iSIMs can be integrated directly into a device (e.g., IoT device(s) 302) and are non-swappable. iSIMs can also support remote management for use in IoT devices such as the IoT devices 302. In some cases, an iSIM may require less supporting hardware than an eSIM. For example, eSIMs may typically require their own processors and other hardware components, which can increase the hardware footprint of an associated device considerably. iSIMs can be provided in a manner that is further integrated into the hardware of their associated devices (e.g., as part of an overall System-on-a-Chip (SoC) solution for the device).

In one illustrative example, SIM/eSIM/iSIM/etc. can be used to bootstrap ZTD and eliminate many friction points that exist in current cellular device onboarding processes including configuration of IoT devices with ZTD specific parameters including ZTD APN, URL, etc.

FIG. 4 illustrates an example ZTD agent, according to some aspects of the present disclosure. As illustrated, ZTD agent 400 may include any or all of the following sub-components: a connection client 402, an Enrollment over Secure Transport (EST) client 404, a root certificate 406, and/or a private APN data and credential 408. In some examples, one or more of the sub-components 402-408 can be combined, omitted, or integrated into other processes, without departing from the scope of the present disclosure.

In one illustrative example, ZTD agent 400 can be installed to an endpoint device (e.g., one or more of the IoT devices 302 illustrated in FIG. 3) during the manufacturing of the endpoint device. In some aspects, ZTD agent 400 can be used across any number of different end users/entities and deployments (e.g., various enterprise networks used by companies, schools, governments, etc.) without requiring customization specific to a particular end user/entity and/or deployment. In some examples, ZTD agent 400 can be provided or otherwise utilized without the need for the manufacturer to install one or more certificates.

During the onboarding process, connection client 402 can be used to establish an initial connection between a device executing the ZTD agent 400 (e.g., an IoT device 302) and a ZTD service. For example, with reference to the examples of FIGS. 3 and 4, the connection client 402 executed by an IoT device 302 can cause the IoT device 302 to connect with a corresponding base station 304 and send a registration request to ZTD service 310.

In some examples, EST client 404 can be used to manage and request the installation of certificates to the device executing ZTD agent 400. For example, EST client 404 can manage and/or request the installation of one or more certificates that are associated with an entity (e.g., an enterprise or other user) that owns the IoT device 302. Details on the EST protocol can be found in the Internet Engineering Task Force (IETF) Request for Comments 7030 entitled, “Enrollment over Secure Transport” by Pritiken, et al. In some examples, EST client 404 can be provided as another client sub-component of ZTD agent 400 that relies on another certificate management protocol.

Root certificate 406 can be used by ZTD agent 400 to authenticate the executing device during its communications with its corresponding service. Such a certificate may be issued by a certificate authority (CA), in accordance with a public key infrastructure framework.

Private APN data and credentials 408 can be used by ZTD agent 400 to connect its device to a private APN operated by the cellular carrier and associated with the ZTD service. For example, as illustrated in FIG. 3, the ZTD agent (e.g., ZTD agent 400) of an IoT device 302 may supply the private APN and credentials 408 to the IoT device 302, such that the IoT device 302 can connect to an APN associated with the provider of ZTD service 310. In some examples, the private APN can allow the IoT device 302 to access the cellular carrier's network 306 via a minimal data plan for purposes of onboarding the IoT device 302. As a result, in some examples a secure tunnel 308 associated with the APN can be formed with ZTD service 310. In some cases, network services such as Domain Name System (DNS) services, Dynamic Host Configuration Protocol (DHCP) services, etc., in network 306 can be controlled in this captive network.

From the standpoint of ZTD service 310, the above approach can help ensure network security, as only allowed/known IoT devices 302 (e.g., devices with known SIMs) can connect to ZTD service 310 through a corresponding tunnel 308 connecting the service provider (SP) network 306 to that of ZTD service 310. In some examples, one or more of the IoT devices 302 may be known via their SIM/eSIM/iSIM information, which is also known by the device management platform 312 via its SIM onboarding workflow.

In some examples, the IoT devices 302 effectively connect to a private ZTD network using private APN and a virtual private network (VPN) tunnel 308, and ZTD services from ZTD service 310 are not accessible from the public Internet. In some cases, the original IP headers of packets sent by IoT devices 302 to ZTD service 310 are not modified, such as by a network address translation (NAT) service. It is additionally noted that one or more of the IoT devices 302 themselves may not be accessible by any service other than ZTD service 302 during the onboarding process, providing additional security.

In some examples, the cellular SP network 306 can be configured to work with both the private APN associated with ZTD service 310, as well as with a target APN. In some examples, the cellular SP network 306 may be reconfigured to allow the SIM/eSIM/iSIM/etc., of an IoT device 302 to switch to the target APN in an orchestrated manner during onboarding of the IoT device 302.

With examples ZTD architecture and deployment thereof within an enterprise network described with reference to FIGS. 1-4, the disclosure now turns to techniques for eliminating the need for configuring (e.g., hard coding) IoT devices during manufacturing with ZTD specific configurations including ZTD APNs, URLs, etc. This process may be referred to as zero-configuration during zero-touch deployment of IoT devices.

Zero configuration techniques for zero-touch deployment of IoT devices may leverage a ZTD agent such as ZTD agent 400, ZTD SaaS service such as ZTD service 310, and an enterprise control center such as device management platform 312. As noted, IoT devices are manufactured with a ZTD agent. By implementing the techniques described herein, the IoT devices and a ZTD agent installed on each need not be customized per customer configurations (e.g., do not need to have ZTD specific credentials configured thereon) nor require a manufacturer installed certificate.

FIG. 5 describes a process for zero-touch configuration of IoT devices, according to some aspects of the present disclosure. FIG. 5 will be described with reference to one or more of FIGS. 1-4 and from the perspective of ZTD service 310 of FIG. 3. It will be understood that ZTD service 310 may be a local or cloud-based computing component with one or more memories having computer-readable instructions stored therein and one or more processors. The one or more processors may be configured to execute the computer-readable instructions to implement steps of FIG. 5 described below.

Prior to describing steps of FIG. 5, it should be noted that an enterprise network operator, via device management platform 312, may define a communication plan. As part of this communication plan, the network operator may define a default APN (which will replace a blank APN in a message received from IoT device 302 during initial attachment message) and a URL as ZTD specific configurations. It should be noted that the communication plan may include any number of additional configurations to be applied to connected IoT devices (e.g., security parameters, software updates, connectivity conditions, etc.). In some examples, communication plans may be specific to a particular group or class of IoT devices, all of which may be specified in the communication plan by a network operator.

Such communication plan may then be exchanged with ZTD service 310 via any known or to be developed communication scheme. In some examples, ZTD service 310 may not be unique or exclusive to a particular enterprise network. For example, both ZTD service 310 and device management platform 312 may be cloud-based services offered by providers of enterprise networks. Multiple enterprises may be tenants and users of such cloud-based services. Accordingly, ZTD service 310 may receive communication plans for multiple enterprises.

Additionally, IoT device 302 may have a ZTD agent installed thereon such as ZTD agent 400. Furthermore, IoT device 302 may be issued a device certificate by a certificate authority (not shown). The certificate authority may be associated with the tenant that owns IoT device 302 containing a SIM card. As part of registration with ZTD service 310, IoT device 302 may claim that it has an ICCID, (e.g., <xyz>), an IMEI (e.g., <pqr>). In turn, ZTD service 310 can validate this information as follows.

A Transport Layer Session (TLS) with IoT device 302 is kept unbroken and the following is checked during the active TLS session.
IoT device 302 is communicating with ZTD service 310 using source IP address (e.g., <a.b.c.d>); Device management platform 312 directs ZTD service 310 that the IP address (e.g., <a.b.c.d>) is currently associated with ICCID (e.g., <xyz>) and IMEI (e.g., <pqr>);
The following transactions happen under the unbroken TLS session, as well:
   Device management platform 312 directs ZTD service 310 that ICCID <xyz> is associated with a tenant (e.g., <tuv>, <McDonald's>, etc.)
   Based on the above validation steps, ZTD service 310 allows a Certificate Authority associated with the tenant (e.g., <tuv>) to sign the device certificate.
In addition, when device management platform 312 directs ZTD service 310 that IP address (e.g., <a.b.c.d>) is currently associated with ICCID (e.g., <abc>) and IMEI (e.g., <defy), this assertion can be trusted for the following reasons:
   Device management platform 312 trusts the cellular packet core;
   HLR/HSS, part of the cellular packet core, trusts the SIM card inside IoT device 302 due to the secrets that SIM card has and since its database has the corresponding secrets associated with the SIM's ICCID;
   AAA and DHCP services, part of the packet core, trust HLR/HSS and based on this IoT device 302 with the SIM card is given IP address (e.g., <a.b.c.d>).
Device's session state is updated with this IP address (e.g., <a.b.c.d>).
   Also, IMEI reported by the MME for this device is noted. In another example, the authentication of IoT device 302 can also be based in part on location information regarding IoT device 302. For example, if the deployment location for IoT device 302 is known in advance (e.g., a particular building, etc.), location information can be included in the authentication data, to ensure that IoT device 302 attempting the onboarding is actually the deployed device. It should be noted that techniques described herein leverage existing metadata information in the cellular connection management processes, by using them in policies for zero-touch deployment to choose items such as certificate authority, type of certificates and the target APN.

Returning to the process 500 of FIG. 5 and assuming communication plans are specified, at step 510, ZTD service 310 may receive the communication plan from device management platform 312. The communication plan may specify, among other parameters, that a single APN access is allowed to be configured on each connected IoT device.

At step 520, ZTD service 310 may receive a message from one or more IoT devices 302 (hereinafter referred to as the IoT device 302 for simplicity. However, it should be noted that such messages may be received from more than one IoT device 302 and may also be received simultaneously). This message may be received as part of the initial bootstrap phase for IoT device 302 to connect to ZTD service 310 (to a server providing ZTD service 310, which may also be referred to as the ZTD server). The one or more IoT devices 302 from which a registration message is received may not necessarily be associated with the same enterprise network and instead may be associated with different enterprise networks.

In one example, the message received at step 530 may include a blank APN definition (e.g., in a PDP context definition of the message) and a non-ZTD specific URL.

For IoT device 302 to establish a connection to ZTD service 310, IoT device 302 should be provisioned with an APN that allows IoT device 302 to connect to the network containing the ZTD server. In other words, IoT device 302 should be provisioned with a ZTD specific APN. Moreover, IoT device 302 should also have URL that allows the device to connect to the ZTD service. In other words, IoT device 302 should be provisioned with a ZTD specific URL. As noted, the techniques herein eliminate the need for pre-provisioning of IoT devices with ZTD specific configurations such as ZTD specific APN and URL. The message can simply include no APN and any URL, which will be modified by ZTD service 310 upon receipt of the message with the correct ZTD specific APN and URL, as will be described below.

At step 530, ZTD 310 replaces a blank APN included in the message with the ZTD specific APN to allow IoT device 302 access to a ZTD server.

At step 540 and after provisioning the ZTD specific APN for IoT device 302, ZTD 310 may update the communication at device management platform 312 (network controller) to include the ZTD specific APN. ZTD specific APN may also be referred to as a production APN. In one example, ZTD 310 may make an API call to device management platform 312 to update the communication plan. In one example and concurrently with updating the communication plan at device management platform 312, ZTD 310 also updates an IoT hub with the ZTD specific APN.

At step 550, ZTD 310 may resolve the non-ZTD specific URL included in the message received at step 520 with a ZTD specific URL using a Domain Name Service (DNS) resolver. A custom DNS resolver may be used in the ZTD captive network (e.g., an Amazon Web Services Virtual Private Cloud (VPC) within a VPN pointed to by the ZTD APN). Because ZTD service 310 is the only service in the network, the custom resolver will always return the internal address of ZTD service 310 for any host specified in the non-ZTD specific URL.

In one example, steps 530, 540, and 550 may collectively be referred to as a step for provisioning the IoT device with ZTD specific configurations (e.g., ZTD specific APN and ZTD specific URL).

At step 560, ZTD 310 may completing bootstrapping process for IoT device 302 in order for IoT device 302 to connect to ZTD service 310.

In one or more examples embodiments, ZTD service 310 can host device certificates issued by different service providers that utilize ZTD service 310. SIM based devices can access the key certificate(s) of their own service providers, which they can use to trust ZTD service 310.

The zero-touch configuration techniques disclosed herein provide a number of advantages. For instance, by provisioning IoT devices during runtime without pre-configuring each with ZTD specific configurations, would require less initial configuration that in turn can enhance and streamline the process of adopting and using IoT devices in networks. Doing so would also avow tenants and customers of enterprise networks to “redirect” the APN dynamically from the back-end (e.g., from device management platform 312 with no changes to the IoT devices), creating a new feature whereby the customer could steer their devices to a new ZTD instance. Similarly, doing so would allow tenants to “redirect” the URL dynamically from the back-end (e.g., from device management platform 312 with no changes to the IoT devices), creating a new feature whereby the customer could steer their devices to a new ZTD service URL (e.g., one with perhaps with differentiated features).

ZTD services such as ZTD 310 reduce the complexity of the device implementation by providing a cloud service that offloads much of the PKI infrastructure setup and management. Device setup requirements on the devices to use the ZTD service require some “staging” operations, however, that would be difficult to manage in the manufacturing supply chain. The zero-touch deployment techniques described herein removes a number of impediments to simple adoption and use of IoT devices in the network. The techniques disclosed provide the ability to redirect a device's network connection and HTTP URL enables compelling new features available nowhere else in the market

With various examples of enterprise networks, ZTD services implemented in such networks and zero-touch configuration of IoT devices described above with reference to FIGS. 1-5, the disclosure now turns to FIGS. 6 and 7 that describe example network devices and computing devices. Such example network and computing devices may be used to implement various components described above with reference to FIGS. 1-6 including, but not limited to, components of architecture 100, architecture 250, architecture 300 including ZTD service 310, device management platform 312, and ZTD agent 400.

FIG. 6 illustrates an example of a network device, according to some aspects of the present disclosure. FIG. 6 illustrates an example network device 600 suitable for performing switching, routing, load balancing, and other networking operations. Network device 600 includes a central processing unit (CPU) 604, interfaces 602, and a bus 610 (e.g., a PCI bus). When acting under the control of appropriate software or firmware, the CPU 604 is responsible for executing packet management, error detection, and/or routing functions. The CPU 604 preferably accomplishes all these functions under the control of software including an operating system and any appropriate applications software. CPU 604 may include one or more processors 608, such as a processor from the INTEL X86 family of microprocessors. In some cases, processor 608 can be specially designed hardware for controlling the operations of network device 600. In some cases, a memory 606 (e.g., non-volatile RAM, ROM, etc.) also forms part of CPU 604. However, there are many different ways in which memory could be coupled to the system.

The interfaces 602 are typically provided as modular interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 604 to efficiently perform routing computations, network diagnostics, security functions, etc.

Although the system shown in FIG. 6 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 606 could also hold various software containers and virtualized execution environments and data.

The network device 600 can also include an application-specific integrated circuit (ASIC), which can be configured to perform routing and/or switching operations. The ASIC can communicate with other components in the network device 600 via the bus 610, to exchange data and signals and coordinate various types of operations by the network device 600, such as routing, switching, and/or data storage operations, for example.

FIG. 7 illustrates an example computing system, according to some aspects of the present disclosure. FIG. 7 illustrates an example computing system 700 including components in electrical communication with each other using a connection 705 upon which one or more aspects of the present disclosure can be implemented. Connection 705 can be a physical connection via a bus, or a direct connection into processor 710, such as in a chipset architecture. Connection 705 can also be a virtual connection, networked connection, or logical connection.

In some embodiments computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A method comprising:
receiving, at a zero-touch deployment (ZTD) service and from an Internet of Things (IoT) device, a message for establishing a connection to the ZTD service;
provisioning, at the zero-touch deployment service, the IoT device with ZTD specific configurations based on a communication plan received at the ZTD service for the IoT device, wherein the ZTD service provisions the IoT device by replacing a non-ZTD specific Access Point Name (APN) in the message with the ZTD specific APN and replacing a non-ZTD specific Uniform Resource Locator (URL); and
completing, at the zero-touch deployment service, initial bootstrapping of the IoT device to establish the connection to the ZTD service using the ZTD specific configurations.

2. (canceled)

3. (canceled)

4. The method of claim 1, wherein replacing the non-ZTD specific URL with the ZTD specific URL includes resolving the non-ZTD specific URL using a Domain Name Service (DNS) resolver.

5. The method of claim 1, wherein the non-ZTD specific APN is a blank APN definition and the blank APN definition is replaced with the ZTD specific APN.

6. The method of claim 5, wherein the blank APN is included in a Packet Data Protocol (PDP) context definition within the message.

7. The method of claim 1, wherein the IoT device is not pre-provisioned with the ZTD configuration when the message is received at the ZTD service.

8. A server associated with a zero-touch deployment (ZTD) service, comprising:
one or more memories having computer-readable instructions stored therein; and
one or more processors configured to execute the computer-readable instructions to:
receive, from an Internet of Things (IoT) device, a message for establishing a connection to the ZTD service;
provision the IoT device with ZTD specific configurations based on a communication plan received at the ZTD service for the IoT device, wherein the ZTD service provisions the IoT device by replacing a non-ZTD specific Access Point Name (APN) in the message with the ZTD specific APN and replacing a non-ZTD specific Uniform Resource Locator (URL); and
complete initial bootstrapping of the IoT device to establish the connection to the ZTD service using the ZTD specific configurations.

9. (canceled)

10. (canceled)

11. The server of claim 8, wherein the server is configured to replace the non-ZTD specific URL with the ZTD specific URL by resolving the non-ZTD specific URL using a Domain Name Service (DNS) resolver.

12. The server of claim 8, wherein the non-ZTD specific APN is a blank APN definition and the blank APN definition is replaced with the ZTD specific APN.

13. The server of claim 12, wherein the blank APN is included in a Packet Data Protocol (PDP) context definition within the message.

14. The server of claim 10, wherein the IoT device is not pre-provisioned with the ZTD configuration when the message is received at the ZTD service.

15. One or more non-transitory computer-readable media comprising computer-readable instructions, which when executed by one or more processors of a zero-touch deployment (ZTD) server, cause the ZTD server to:
receive, from an Internet of Things (IoT) device, a message for establishing a connection to the ZTD server;
provision the IoT device with ZTD specific configurations based on a communication plan received at the ZTD service for the IoT device, wherein the ZTD service provisions the IoT device by replacing a non-ZTD specific Access Point Name (APN) in the message with the ZTD specific APN and replacing a non-ZTD specific Uniform Resource Locator (URL); and
complete initial bootstrapping of the IoT device to establish the connection to the ZTD server using the ZTD specific configurations.

16. (canceled)

17. (canceled)

18. The one or more non-transitory computer-readable media of claim 15, wherein the execution of the computer-readable instructions further cause the server to replace the non-ZTD specific URL with the ZTD specific URL by resolving the non-ZTD specific URL using a Domain Name Service (DNS) resolver.

19. The one or more non-transitory computer-readable media of claim 15, wherein the non-ZTD specific APN is a blank APN definition and the blank APN definition is replaced with the ZTD specific APN.

20. The one or more non-transitory computer-readable media of claim 19, wherein the blank APN is included in a Packet Data Protocol (PDP) context definition within the message.
